(19) United States
(12) Patent Application Publication
(10) Pub. No.: US 2021/0078085 A1
(43) Pub. Date: Mar. 18, 2021

(54) CUTTING SECTION FOR A DRILL BIT

(71) Applicant: Hilti Aktiengesellschaft, Schaan (LI)

(72) Inventors: Florian SCHROEDER, Maienfeld (CH); Guenter DOMANI, Weissensberg (DE); Pingyan RONG, Feldkirch (AT)

(21) Appl. No.: 16/954,428

(22) PCT Filed: Dec. 17, 2018
(86) PCT No.: PCT/EP2018/085137

§ 371 Date: Jun. 16, 2020

(30) Foreign Application Priority Data
Dec. 21, 2017 (EP) 17209442.7

(51) Int. Cl. B23B 51/04

(52) U.S. Cl. CPC B23B 51/0473

(57) ABSTRACT

A cutting section (11) which is connectable to a drill shaft section via a releasable connecting device. The cutting section includes a first closed tubular element (14) which is in the form of a first hollow cylinder, a second closed tubular element (15) which is in the form of a second hollow cylinder, and one or more drill segments (16) which are connected to the first closed tubular element (14) and to the second closed tubular element (15).

### TECHNICAL FIELD

The present invention relates to a cutting section for a drill bit wherein the cutting section is connectable to the drill bit via a releasable connection.

### BACKGROUND

WO 2014/096359 A1 discloses a cutting section for a drill bit, which cutting section is connectable to a drill shaft section of the drill bit via a releasable connecting device. The releasable connecting device is designed here as a combined push and twist connection. A “push and twist connection” refers to releasable connections between a first and a second connecting element, said connecting elements forming a push connection in one direction and being additionally connected via a twist connection. The cutting section comprises one or more drill segments, a ring section, an outer push element and an annular stop shoulder at the transition from the ring section to the outer push element.

Cutting sections which are connectable with a combined push and twist connection are sold under the product name “Hilti DD X-CM”. The “Hilti DD X-CM” cutting sections comprise a plurality of drill segments, a ring section and an outer push element, wherein an annular stop shoulder for transmitting forces is located at the transition from the ring section to the outer push element. Torque is transmitted with the aid of pin elements which interact with slot-shaped recesses in the outer push element. The “Hilti DD X-CM” cutting sections are produced from a closed tubular element. In this case, the annular stop shoulder is produced by turning and the slot-shaped recesses are produced by milling.

### SUMMARY OF THE INVENTION

Disadvantages of the known “Hilti DD X-CM” cutting sections are the high outlay on production due to the turning of the annular stop shoulder and the milling of the slot-shaped recesses. In addition, the choice of material for the ring section and the outer push element is limited. Since the “Hilti DD X-CM” cutting sections are produced from a closed tubular element, a compromise has to be made in the choice of material in terms of the demands made of the cutting section regarding transmission of force, transmission of torque and tensile loadings during removal of a jammed drill bit.

An object of the present invention is to improve the functionality of a cutting section during drilling in respect of transmission of force and transmission of torque and tensile loadings during removal of a jammed drill bit. In addition or alternately, the manufacturing outlay for the production of a cutting section is intended to be reduced.

The cutting section is provided for a drill bit and is connectable to a drill shaft section of the drill bit via a releasable connecting device. The cutting section is characterized by:
a first closed tubular element which is in the form of a first hollow cylinder with a first outer lateral surface, a first inner lateral surface, a first lower end surface and a first upper end surface and which has a first hollow cylinder height, a first inside diameter and a first outside diameter,
a second closed tubular element which is in the form of a second hollow cylinder with a second outer lateral surface, a second inner lateral surface, a second lower end surface and a second upper end surface and which has a second hollow cylinder height, a second inside diameter and a second outside diameter, wherein the first outside diameter is smaller than the second inside diameter, and the first outer lateral surface touches the second inner lateral surface, and
one or more drill segments,

wherein the first closed tubular element is pushed into the second closed tubular element and the one or more drill segments are connected to the first closed tubular element and to the second closed tubular element.

The cutting section according to the invention comprises a first closed tubular element, a second closed tubular element and at least one drill segment. The first closed tubular element is in the form of a first hollow cylinder and comprises a first outer lateral surface, a first inner lateral surface, a first lower end surface and a first upper end surface. The second closed tubular element is in the form of a second hollow cylinder and comprises a second outer lateral surface, a second inner lateral surface, a second lower end surface and a second upper end surface. In order to manufacture the cutting section, the first closed tubular element and the second closed tubular element are pushed one into the other and the one or more drill segments are connected to the first closed tubular element and to the second closed tubular element. In respect of the stability of the cutting section, it is advantageous if the drill segments are connected to the first and second closed tubular elements.

The cutting section is designed in such a manner that force is transmitted from a drill shaft section via the first closed tubular element to the drill segments and torque is transmitted from the drill shaft section via the second closed tubular element to the drill segments. The first upper end surface of the first closed tubular element forms an annular stop shoulder which is used for transmitting force. A drill shaft section transmits the force to the annular stop shoulder by means of an annular end surface. Torque is transmitted, for example, via pin elements of the drill shaft section which interact with slot-shaped recesses in the second closed tubular element. By separation of the cutting section into the first closed tubular element and the second closed tubular element, the different demands made of the cutting section in respect of transmission of force and transmission of torque can be taken into consideration.

In addition, by separation of the cutting section into the first closed tubular element and the second closed tubular element, the manufacturing outlay for producing the cutting section can be reduced. The first upper end surface forms the annular stop shoulder for transmitting force, thus obviating the need for turning. The first closed tubular element and the second closed tubular element are in the form of hollow cylinders having circular ring-shaped cross sections, and have a constant material thickness. The first closed tubular element can be produced from a first flat sheet metal part which is formed into a first open tubular element and is connected at first abutting edges in an integrally bonded or interlocking manner. The second closed tubular element can be produced from a second flat sheet metal part which is formed into a second open tubular element and is connected at second abutting edges in an integrally bonded or interlocking manner.

The first lower end surface of the first closed tubular element and the second lower end surface of the second closed tubular element are preferably aligned flush. The flush alignment of the first lower end surface and the second lower end surface has the advantage that a wide attachment surface for the drill segments arises, at which the drill segments can be connected to the first closed tubular element and to the second closed tubular element.

The one or more drill segments are particularly preferably connected to the first lower end surface and to the second lower end surface. The flush alignment of the first lower end surface and the second lower end surface gives rise to a wide attachment surface for the drill segments. If the drill segments are connected to the first lower end surface and to the second lower end surface, the first closed tubular element and the second closed tubular element can be connected simultaneously to the drill segments. If the drill segments are connected to the first and second closed tubular elements simultaneously, the manufacturing outlay can be reduced. Depending on the material thicknesses used, it may be necessary for the first closed tubular element and the second closed tubular element to be additionally connected to each other. Should higher resistance torques be required, the first closed tubular element and the second closed tubular element may be additionally connected to each other.

The second closed tubular element preferably has at least one slot-shaped recess, wherein the at least one slot-shaped recess has a transverse slot and a connecting slot, and the connecting slot connects the transverse slot to the second upper end surface of the second closed tubular element. The at least one slot-shaped recess is part of the releasable connecting device which connects the cutting section to a drill shaft section of the drill bit. The slot-shaped recess is T-shaped or L-shaped and, in the connected state of the drill bit, permits a relative movement between the cutting section and the drill shaft section. The relative movement between the cutting section and the drill shaft section enables a jammed cutting section to be released from the underlying surface.

The second closed tubular element in the second inner lateral surface particularly preferably has at least one transverse groove which is arranged level with the connecting slot of the slot-shaped recess. The at least one transverse groove is part of the releasable connecting device which connects the cutting section to a drill shaft section of the drill bit. The width of the transverse groove is greater than or equal to the width of the transverse slot of the slot-shaped recess. A matching transverse lug of a drill shaft section engages in the transverse groove of the cutting section. The transverse groove and transverse lug form an additional interlocking connection which prevents the push and twist connection from being unintentionally opened during release of a jammed drill bit and the drill shaft section from being removed from the underlying surface without the cutting section.

The first closed tubular element in the first inner lateral surface preferably has at least one internal depression which extends over the first hollow cylinder height. The at least one internal depression in the first inner lateral surface can form a transport channel for a cooling and rinsing liquid and enables the formation of cutting sections with small internal protrusions of the drill segments on the inner side of the cutting section. The width, depth, shape and/or number of the internal depressions are adapted to the required quantity of cooling and rinsing liquid.

In a preferred development, the first closed tubular element is formed from a first material and the second closed tubular element from a second material. The cutting section according to the invention is designed in such a manner that force is transmitted to the cutting section via the first closed tubular element and torque is transmitted to the cutting section via the second closed tubular element. By separation of the cutting section into the first closed tubular element and the second closed tubular element, the choice of the first material for the first closed tubular element and of the second material for the second closed tubular element can be adapted to the different demands made of the cutting section in respect of transmission of force and transmission of torque. In addition, the second material can be adapted in respect of tensile loadings during the removal of a jammed drill bit.

The first closed tubular element is preferably in the form of a first formed sheet metal part. The use of a first formed sheet metal part permits the production of the first closed tubular element from flat sheet metal parts. The first closed tubular element can be produced from a first sheet metal part which is formed into a first open tubular element and is connected at the first abutting edges. Cold forming methods and hot forming methods are suitable as the forming method for the first sheet metal part. The first abutting edges can be connected in an integrally bonded or interlocking manner, with the abutting edges of tubular elements conventionally being connected in an integrally bonded manner by welding. In addition to the integrally bonded connection, the first abutting edges can be connected in an interlocking manner.

The first formed sheet metal part particularly preferably has at least one first positive interlocking element and at least one corresponding first negative interlocking element on opposite sides, wherein the at least one first positive interlocking element and the at least one first negative interlocking element are connected in an interlocking manner in the first closed tubular element. The connection of the first abutting edges via first interlocking elements has the advantage that heat which may lead to stresses in the first closed tubular element is not admitted into the first open tubular element.

The second closed tubular element is preferably in the form of a second formed sheet metal part. The use of a second formed sheet metal part permits the production of the second closed tubular element from flat sheet metal parts. The second closed tubular element can be produced from a second sheet metal part which is formed into a second open tubular element and is connected at the second abutting edges. The at least one slot-shaped recess can be produced in the second sheet metal part, for example, by punching or cutting out. Cold forming methods and hot forming methods are suitable as the forming method for the second sheet metal part. The second abutting edges can be connected in an integrally bonded or interlocking manner, with the abutting edges of tubular elements conventionally being connected in an integrally bonded manner by welding. In addition to the integrally bonded connection, the second abutting edges can be connected in an interlocking manner.

The second formed sheet metal part particularly preferably has at least one second positive interlocking element and at least one corresponding second negative interlocking element on opposite sides, wherein the at least one second positive interlocking element and the at least one second negative interlocking element are connected in an interlocking manner in the second closed tubular element. The connection of the second abutting edges via second interlocking elements has the advantage that heat which may lead to stresses in the second closed tubular element is not admitted into the second open tubular element.

The cutting section according to the invention for a drill bit is provided for connection to a drill shaft section of the drill bit. The invention furthermore relates to a drill bit with a cutting section and a drill shaft section, wherein the cutting section and the drill shaft section are connectable via a releasable connecting device.

### BRIEF DESCRIPTION OF THE DRAWINGS

Exemplary embodiments of the invention are described hereinafter with reference to the drawing. It is not necessarily intended for this drawing to illustrate the exemplary embodiments to scale; instead, the drawing, where conducive to elucidation, is executed in schematic and/or slightly distorted form. It should be taken into account here that various modifications and variations relating to the form and detail of an embodiment may be undertaken without departing from the general concept of the invention. The general concept of the invention is not limited to the exact form or the detail of the preferred embodiment shown and described hereinafter or limited to subject matter that would be limited compared with the subject matter claimed in the claims. For given dimensioning ranges, values within the stated limits should also be disclosed as limit values and can be used and claimed as desired. For the sake of simplicity, the same reference numerals are used below for identical or similar parts or parts with identical or similar functions.

In the figures:

FIGS. 1A and 1B show a drill bit with a cutting section according to the invention and a drill shaft section, which are connectable via a releasable connecting device, in an unconnected state of the drill bit (FIG. 1A) and in a connected state of the drill bit (FIG. 1B); and

FIGS. 2A, 2B and 2C show the cutting section according to the invention of FIGS. 1A and 1B consisting of a first closed tubular element, a second closed tubular element and a plurality of drill segments (FIG. 2A showing all and FIG. 2B showing the first closed tubular element and FIG. 2C the second closed tubular element) in a longitudinal section along the section line A-A in FIG. 1A.

### DETAILED DESCRIPTION

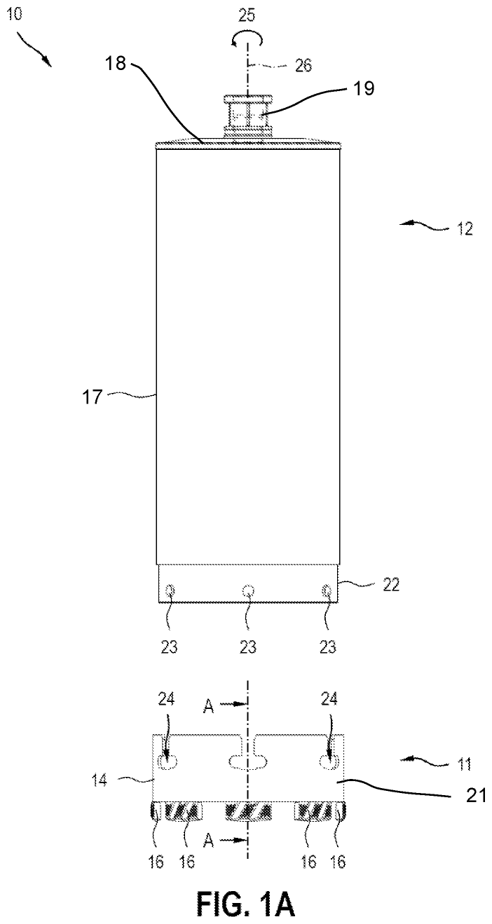

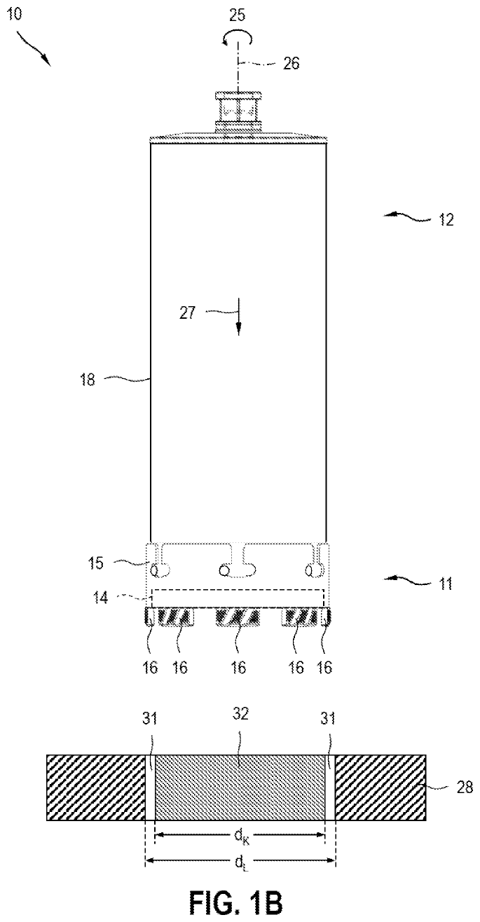

FIGS. 1A and 1B show a drill bit 10 which comprises a cutting section 11 according to the invention and a drill shaft section 12, wherein the cutting section 11 and the drill shaft section 12 are connectable via a releasable connecting device 13. In this case, FIG. 1A shows the cutting section 11 and drill shaft section 12 in an unconnected state of the drill bit, and FIG. 1B shows the cutting section 11 and drill shaft section 12 in a connected state of the drill bit.

The cutting section 11 comprises a first closed tubular element 14, a second closed tubular element 15 and a plurality of drill segments 16 which are connected to the first closed tubular element 14 and to the second closed tubular element 15. The drill segments 16 are connected to the first closed tubular element 14 and to the second closed tubular element 15, wherein the first and second tubular elements 14, 15 are likewise connected to each other in the region of the connection. When required, the first closed tubular element 14 and the second closed tubular element 15 can additionally be connected to each other.

The drill segments 16 are arranged annularly and form a drill ring with intermediate spaces. Instead of a plurality of drill segments 16, the cutting section 11 can also have an individual drill segment which is in the form of a closed drill ring. The drill segments 16 can be welded, soldered or screwed to the first closed tubular element 14 and to the second closed tubular element 15 or fastened to the first closed tubular element 14 and to the second closed tubular element 15 using another suitable type of fastening. The drill shaft section 12 comprises a tubular drill shaft 17, a cover 18 and a push-in end 19 via which the drill bit 10 is fastened in a tool holder of a core drill.

The releasable connecting device 13 is in the form of a combined push and twist connection, as disclosed in WO 2014/096359 A1. The releasable connecting device 13 comprises a first push element 21 which is integrated in the cutting section 11, and a second push element 22 which is integrated in the drill shaft section 12. The first and second push elements 21, 22 form a push connection and are additionally secured via a twist connection. The twist connection comprises a plurality of pin elements 23 which are introduced into slot-shaped recesses 24. The pin elements 23 are fastened to an outer side of the second push element 22, and the slot-shaped recesses 24 are provided in the first push element 21. The cutting section 11 can be connected simply and rapidly to the drill shaft section 12 by the operator. For this purpose, the cutting section 11 with the first push element 21 is pushed onto the second push element 22 of the drill shaft section 12 in such a manner that the pin elements 23 are arranged in the slot-shaped recesses 24.

In the drilling mode, the drill bit 10 is driven by a core drill in a direction of rotation 25 about an axis of rotation 26, wherein the axis of rotation 26 coincides with a longitudinal axis of the tubular drill shaft 17. During the rotation of the drill bit 10 about the axis of rotation 26, the drill bit 10 is moved in a feed direction 27 into a workpiece 28, with the feed direction 27 running parallel to the axis of rotation 26. In the workpiece 28, the drill bit 10 produces a drill hole 31 with a drill hole diameter d_{L} and a drill core 32 with a core diameter d_{K}. The drill segments 15 form a drill ring with an outside diameter which corresponds to the drill hole diameter d_{L} and with an inside diameter which corresponds to the core diameter d_{K}.

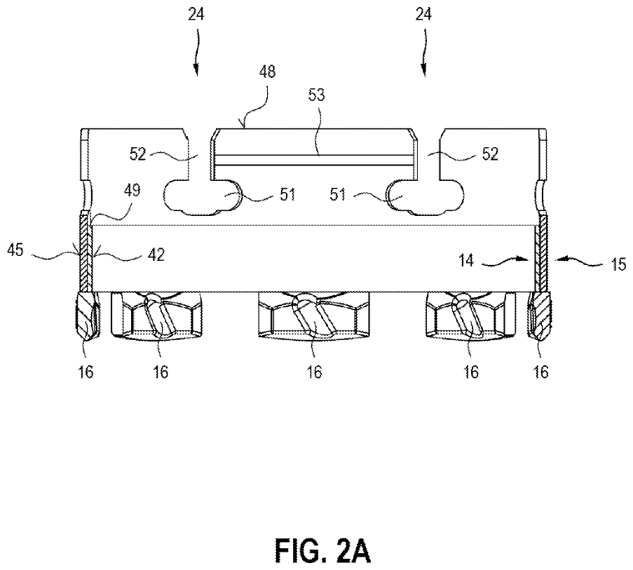

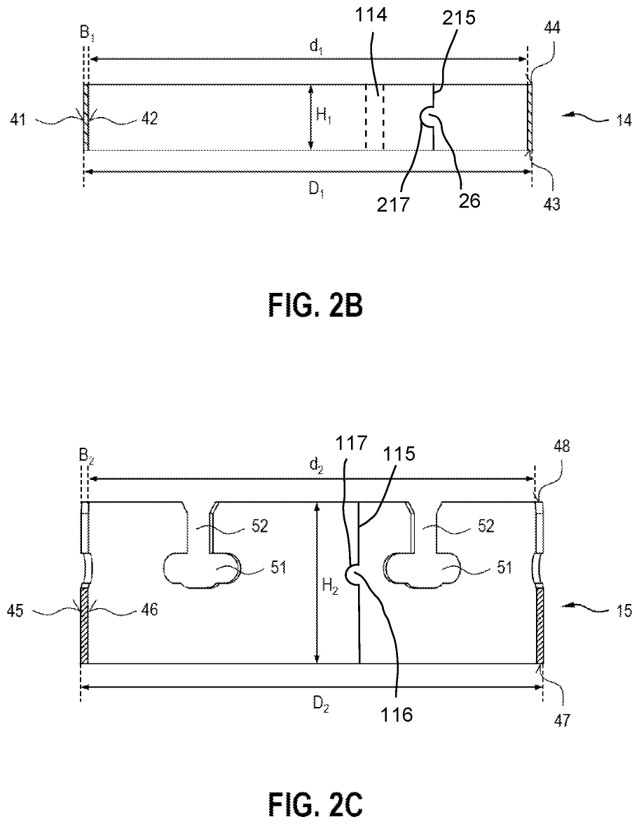

FIGS. 2A, 2B and 2C show the cutting section 11 according to the invention of FIG. 1 with the first closed tubular element 14, the second closed tubular element 15 and the drill segments 16 in a longitudinal section along the section line A-A in FIG. 1A. FIG. 2B shows the first closed tubular element 14 and FIG. 2C shows the second closed tubular element 15 of the cutting section 11.

The cutting section 11 is produced from the first closed tubular element 14, the second closed tubular element 15 and the drill segments 16. The drill segments 16 are connected to the first closed tubular element 14 and to the second closed tubular element 15. The drill segments 16 can be welded, soldered or screwed to the first closed tubular element 14 and to the second closed tubular element 15 or fastened thereto using another suitable type of fastening.

As shown in FIG. 2B, the first closed tubular element 14 is in the form of a first hollow cylinder having a circular ring-shaped cross-sectional area. The first closed tubular element 14 comprises a first outer lateral surface 41, a first inner lateral surface 42, a first lower end surface 43 and a first upper end surface 44. The dimensions of the first closed tubular element 14 are defined by a first hollow cylinder height H₁, a first inside diameter d₁ and a first outside diameter D₁. The width of the first closed tubular element 14 is produced as half the difference of the first outside diameter D₁ and the first inside diameter d₁ and is referred to as the first width B₁. In the first inner lateral surface 42 the first open tubular element 14 preferably has at least one internal depression 114 which extends over the first hollow cylinder height H₁. As shown schematically, the first closed tubular element 14 can be connected at first abutting edges 215 in an interlocking manner with a first positive interlocking element 216 and a second negative interlocking element 217.

As shown in FIG. 2C, the second closed tubular element 15 is in the form of a second hollow cylinder having a circular ring-shaped cross-sectional area. The second closed tubular element 15 comprises a second outer lateral surface 45, a second inner lateral surface 46, a second lower end surface 47 and a second upper end surface 48. The dimensions of the second closed tubular element 15 are defined by a second hollow cylinder height H₂, a second inside diameter d₂ and a second outside diameter D₂. The width of the second closed tubular element 15 is produced as half the difference of the second outside diameter D₂ and the second inside diameter d₂ and is referred to as the second width B₂. As shown schematically, the second closed tubular element 15 can be connected at second abutting edges 115 in an inter-locking manner with a second positive interlocking element 116 and a second negative inter-locking element 117.

The first lower end surface 43 of the first closed tubular element 14 and the second lower end surface 47 of the second closed tubular element 15 are aligned flush. The flush alignment of the first lower end surface 43 and the second lower end surface 47 has the advantage that a wide attachment surface for the drill segments 16 arises, at which the drill segments 16 can be connected to the first closed tubular element 14 and to the second closed tubular element 15. If the drill segments 16 are connected to the first lower end surface 43 and to the second lower end surface 47, the first closed tubular element 14 and the second closed tubular element 15 can be connected simultaneously to the drill segments 16. Depending on the material thicknesses used, it may be necessary for the first closed tubular element 14 and the second closed tubular element 15 to be additionally connected to each other.

The cutting section 11 is designed in such a manner that force is transmitted from the drill shaft section 12 via the first closed tubular element 14 to the drill segments 16 and torque is transmitted from the drill shaft section 12 via the second closed tubular element 15 to the drill segments 16. The first upper end surface 44 of the first closed tubular element 14 forms an annular stop shoulder 49 on the inner side of the cutting section 11 for the transmission of force from a connected drill shaft section. Torque is transmitted from the drill shaft section 12 to the cutting section 11 via the pin elements 23 and the slot-shaped recesses 24. The second closed tubular element 15 of the cutting section 11 has a plurality of slot-shaped recesses 24 on the second upper end surface 48. The slot-shaped recesses 24 each comprise a transverse slot 51 and a connecting slot 52, wherein the connecting slot 52 connects the transverse slot 51 to the second upper end surface 48.

The first closed tubular element 14 can be produced from a first material and the second closed tubular element 15 from a second material. By separation of the cutting section 11 into the first closed tubular element 14 and the second closed tubular element 15, the choice of the first material can be adapted to the demands made of the first closed tubular element 14 and the choice of the second material to the different demands made of the second closed tubular element 15.

What is claimed is:

1-12. (canceled)

13. A cutting section for a drill bit, the cutting section being connectable to a drill shaft section of the drill bit via a releasable connection, the cutting section comprising:
a first closed tubular element in the form of a first hollow cylinder with a first outer lateral surface, a first inner lateral surface, a first lower end surface and a first upper end surface, and having a first hollow cylinder height, a first inside diameter and a first outside diameter;
a second closed tubular element in the form of a second hollow cylinder with a second outer lateral surface, a second inner lateral surface, a second lower end surface and a second upper end surface, and having a second hollow cylinder height, a second inside diameter and a second outside diameter, wherein the first outside diameter is smaller than the second inside diameter, and the first outer lateral surface touches the second inner lateral surface; and
at least one drill segment;
the first closed tubular element being pushed into the second closed tubular element, and the at least one drill segment being connected to the first closed tubular element and to the second closed tubular element.

14. The cutting section as recited in claim 13 wherein the first lower end surface and the second lower end surface are aligned flush.

15. The cutting section as recited in claim 14 wherein in that the at least one drill segment is connected to the first lower end surface and to the second lower end surface.

16. The cutting section as recited in claim 13 wherein in the second closed tubular element has at least one slot-shaped recess, the at least one slot-shaped recess including a transverse slot and a connecting slot, and the connecting slot connects the transverse slot to the second upper end surface of the second closed tubular element.

17. The cutting section as recited in claim 16 wherein the second closed tubular element in the second inner lateral surface has at least one transverse groove arranged level with the connecting slot.

18. The cutting section as recited in claim 13 wherein the first closed tubular element in the first inner lateral surface has at least one internal depression extending over the first hollow cylinder height.

19. The cutting section as recited in claim 13 wherein the first closed tubular element is formed from a first material and the second closed tubular element from a second material.

20. The cutting section as recited in claim 13 wherein the first closed tubular element is in the form of a first formed sheet metal part.

21. The cutting section as recited in claim 20 wherein the first formed sheet metal part has at least one first positive interlocking element and at least one corresponding first negative interlocking element on opposite sides, wherein the at least one first positive interlocking element and the at least one first negative interlocking element are connected in an interlocking manner in the first closed tubular element.

22. The cutting section as recited in claim 13 wherein the second closed tubular element is in the form of a second formed sheet metal part.

23. The cutting section as claimed in claim 22 wherein the second formed sheet metal part has at least one second positive interlocking element and at least one corresponding second negative interlocking element on opposite sides, wherein the at least one second positive interlocking element and the at least one second negative interlocking element are connected in an interlocking manner in the second closed tubular element.

24. A drill bit comprising:
the cutting section as recited in claim 13; and
the drill shaft section, the cutting section and the drill shaft section connectable via the releasable connection.
